(19) United States
(12) Patent Application Publication
(10) Pub. No.: US 2025/0218632 A1
(43) Pub. Date: Jul. 3, 2025

(54) BALLS COMPRISING A FERRITE MATERIAL AND USE OF BALLS COMPRISING A FERRITE MATERIAL

(71) Applicant: TDK Electronics AG, Muenchen (DE)

(72) Inventor: Jan Simecek, Novy Malin (CZ)

(21) Appl. No.: 18/875,436

(22) PCT Filed: Jun. 20, 2023
(86) PCT No.: PCT/EP2023/066645

§ 371 Date: Dec. 16, 2024

(30) Foreign Application Priority Data
Jun. 21, 2022 (DE) 102022115371.1

(51) Int. Cl. H01F 1/34

(52) U.S. Cl. CPC H01F 1/344

(57) ABSTRACT

In an embodiment balls include a ferrite material, wherein a diameter of the balls is 3 mm≤D≤15 mm, wherein a density of the respective ball is ≤4200 kg/m³, and wherein the density is ≥3000 kg/m³.

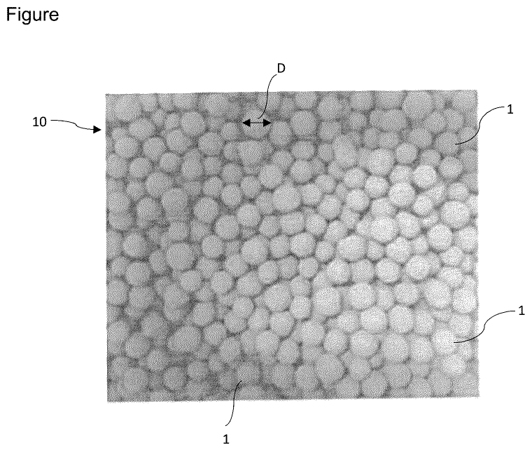

### CROSS-REFERENCE TO RELATED APPLICATIONS

This patent application is a national phase filing under section 371 of PCT/EP2023/066645, filed Jun. 20, 2023, which claims the priority of German patent application no. 102022115371.1, filed Jun. 21, 2022, each of which is incorporated herein by reference in its entirety.

### TECHNICAL FIELD

The present invention relates to balls which comprise a ferrite material. Moreover, the invention relates to a use of a plurality of balls comprising a ferrite material.

### BACKGROUND

Magnetic properties of magnetic materials like cement or concrete are achieved by filling of the material with soft-magnetic material, e.g. MnZn-ferrite ceramics. The filling factor of the magnetic material in the final suspension is main parameter to magnetic properties like efficient permeability.

Common material used in various magnetic mixtures like cement or concrete is sintered ferrite powder which is milled to a specific particle size distribution. However, maximal size of the particles brings a certain limit for the maximal achievable permeability in the final mixture. The very fine particles achieved by milling have a very irregular shape and this bring complications during mixing and processing of the final mixture especially flowability during the casting processes. The fine particles of the ferrite bind water from the mixture and limit the maximal achievable filling factor. Moreover, high costs are produced as the sintered powder must be milled, dried, crushed, and packed.

Another way of doping magnetic mixtures by ferrite material is to use crushed ferrite cores. As the ferrite material is very hard and brittle the shape of crushed ferrite cores is heterogeneous and sharp and this brings complications during final mixture processing and limits the final filling factor of the magnetic mixture. The filling factor achieved by these irregular particles is low and during the crushing process it is almost not possible to control the particle size distribution. In addition to that, scrapped ferrite cores are a limited source and will not be available in high amounts.

### SUMMARY

Embodiments provide ferrite balls and a method of using a plurality of ferrite balls which solve the above mentioned problems.

According to one embodiment at least one ball, in particular a plurality of balls, is provided. The term “ball” denotes a body of compacted material in a specific (i.e. ball-shaped or rounded) form.

The balls are magnetic. Preferably, the balls comprise a soft-magnetic material. The balls comprise a ferrite material. In particular, the material of the balls may comprise Fe₂O₃, MnO₂ or ZnO. The material of the balls may be of spinel structure type. In one embodiment, the balls may comprise a sintered spinel-structure of MnZn ferrites.

According to one embodiment, the balls are calcinated. Moreover, the balls are sintered. The balls (in the following also “ferrite balls”) may be produced in a conventional disc pelletizing or granulating process and then calcinated and sintered in existing sintering kilns.

As compared to a conventional ferrite powder, a milling and spray drying is omitted when producing the ferrite balls. Also a crushing, wet milling and drying of the sintered balls is not necessary as compared to sintered ferrite powder. Consequently, the ferrite balls are produced in an easy and cheap way. Thus, a very cost-effective product is provided which can be easily produced by conventional methods.

According to one embodiment, the balls have a homogeneous shape. The balls may all have approximately the same outer shape. In particular, all balls may have a rounded outer shape. There are no sharp edges on a surface of the balls. In particular, the surface of the respective ball is smooth.

In this way, the balls can be easily further processed, e.g. mixed with further materials, by using existing mixing technologies. Moreover, by means of the homogeneous shape of the ferrite balls, an excellent flowability of the balls can be achieved.

According to one embodiment, the ferrite balls comprise a controlled size. In other words, a variation in a (predetermined) size of the balls may be only marginal. All balls can be of approximately the same size or balls of different predefined sizes can be deliberately mixed together.

A diameter D of the respective ball may be 3 mm≤D≤15 mm. For example, the diameter of the respective ball may amount to 5 mm, 6 mm, 7 mm or 10 mm. The diameter D of the ferrite balls may be large compared to the size of conventional ferrite powder grains, which ranges from 1 to 200 microns.

By controlling the size and the shape of the ferrite balls, the mixability of the balls by standard mixing technologies used e.g. by concrete industry is facilitated. Thus, the balls can be efficiently and homogenously distributed in final magnetic mixtures by using of existing mixing technologies.

According to one embodiment, a density of the respective ball is ≤4200 kg/m³. The density may be ≥3000 kg/m³.

In other words, the density of the respective ferrite ball is rather low. Therefore, the ferrite balls comprise an excellent flowability and can thus be easily distributed in a base material.

According to one embodiment, the balls have a relative permeability≤200. Thus, the permeability of the balls is high as compared to sintered ferrite powder and compared to crushed ferrite cores.

According to one embodiment, the balls are adapted to be used as a filler material for a magnetic mixture. In other words, the filler material comprises a plurality of the ferrite balls. The filler material may be designed to be mixed with a base material (e.g. an inorganic material) to obtain the magnetic mixture mentioned above. The filler material may be designed to dope the base material.

The filler material comprises a plurality of sintered ferrite balls produced in a conventional disc pelletizing and/or granulating process and then calcinated and sintered in existing sintering kilns. Thus, a very cost-effective filler material is provided which can be easily produced by conventional methods.

According to a further embodiment, a use of a plurality of balls for doping a base material to obtain a magnetic mixture with specific magnetic properties is provided. In other words, the balls may be used as a filler material. The balls may comprise a ferrite material. Preferably, the balls correspond to the ferrite balls described above. Thus, all features described in connection with the ferrite balls also apply for this embodiment and vice versa.

The balls bring high permeability compared to sintered ferrite powder and compared to crushed ferrite cores. Due to their specific properties, the balls enable a homogeneous mixture with the base material and to achieve a good flowability of the final magnetic mixture.

For example, an inorganic base material may be mixed with the ferrite balls. By mixing the base material and the ferrite balls, a magnetic mixture with specific magnetic properties may be obtained. The base material can be mixed with the ferrite balls by using conventional mixing technologies. This makes it easy to integrate the ferrite balls into existing production processes for magnetic mixtures.

A material and/or a filling factor and/or a magnetic permeability (i.e. the relative permeability) of the ferrite balls may be adaptable dependent of
the type of base material, and/or
the intended use of the final magnetic mixture, and/or
the intended further processing of the balls.

In this context, the filling factor reflects a mixing ratio between the ferrite balls and the base material. The material, filling factor and/or the relative permeability of the balls may be chosen such that a high permeability and an optimized flowability of the magnetic mixture can be achieved.

The size of the ferrite balls may be chosen depending on the desired flowability of the magnetic mixture and/or the desired magnetic property of the magnetic mixture and/or the filling factor. In one embodiment, ferrite balls of the same predetermined size may be mixed with the base material to obtain the magnetic mixture. Alternatively, ferrite balls of different predetermined sizes may be mixed with the base material to obtain the magnetic mixture. In this way, an even higher filling factor can be achieved.

As describe above, a diameter of the ferrite balls is between 3 mm and 15 mm. The diameter of the ferrite balls may be large compared to the size of conventional ferrite powder grains, which ranges from 1 to 200 microns. In this way, a high permeability in the final magnetic mixture can be achieved. In addition, the said diameter facilitates the mixability of the balls by standard mixing technologies used by concrete industry, for example. In addition, the controlled diameter of the ferrite balls helps to easily control the filling factor. Good flowability of the final mixture and a controlled filling factor allows producers of magnetic concrete to use the casting process during construction work.

A filling factor of the ferrite balls in the magnetic mixture is ≥70 weight %. The filling factor may amount up to 95 weight %, for example. The filling factor of the ferrite balls in the magnetic mixture may be ≥50% in volume.

When used as a filler material, the balls may comprise different (but predetermined) sizes. In other words, different dimensions of ferrite balls may be combined to form the filler material. A ratio between bigger balls B and smaller balls S may be B/S=70/30. The bigger balls may comprise a diameter of 10 mm, for example. The smaller balls may comprise a diameter of 4 mm or 5 mm, for example. Of course, other mixing ratios B/S may be possible, e.g. B/S=75/25, 80/20 or 85/15. The combination of larger and smaller balls helps to increase the filling factor of the filler material in the magnetic mixture.

When the balls are used as a filler material a ferrite sintered powder may also be mixed with the base material/may be added to the magnetic mixture. The ferrite sintered powder may be a conventional ferrite powder which is milled to specific particle size distribution. The size of the ferrite grains in the sintered powder may be between 1 μm to 200 μm. By combining the ferrite balls and the ferrite sintered powder to obtain a magnetic mixture an even higher filling factor can be achieved.

### BRIEF DESCRIPTION OF THE DRAWINGS

Further features, refinements and expediencies become apparent from the following description of the exemplary embodiments in connection with the FIGURE.

The FIGURE shows a view of ferrite balls 1.

### DETAILED DESCRIPTION OF ILLUSTRATIVE EMBODIMENTS

In the FIGURE, a plurality of balls 1 are shown. The balls 1 are compacted bodies which comprise a rounded outer shape. The balls 1 comprise a magnetic ferrite material, preferably a soft-magnetic ferrite material. In particular, the balls 1 are sintered ferrite balls 1.

To obtain said ferrite balls 1, at first a dry mixing of raw material takes place. The raw material comprises MnZn FER, NiZn FER or MgZn FER, for example.

Afterwards, a standard disc pelletizing process and/or a standard granulating process is performed. After formation of the balls 1, the balls 1 are calcined, packed and delivered to sintering. The sintering takes places in existing sintering kilns. Altogether, only a marginal number of steps is necessary to obtain the ferrite balls 1. The sintered ferrite balls 1 are of spinel structure type.

As can be gathered from the FIGURE, the ferrite balls 1 have a homogeneous shape. In particular, the shape of the ferrite balls 1 is rounded. An outer surface of the respective ball 1 is smooth. There are no sharp edges or protrusions on the outer surface of the balls 1. All balls 1 have the same, i.e. rounded, outer shape.

A density of the respective ball 1 is between 3000 and 4200 kg/m³, whereby the limits are included. A relative permeability of the respective ferrite ball 1, which depends on the size of the ball 1, may be ≥200. The balls 1 can be easily processed and comprise an excellent flowability.

The balls 1 are adapted to be used as a filler material 10. In other words, the balls 1 are adapted to be efficiently and homogenously mixed with a base material (not explicitly shown). When the balls 1 are mixed with the base material, a magnetic mixture (not explicitly shown) with specific properties such as good flowability and high relative permeability is achieved.

The ferrite balls 1 bring high permeability compared to sintered ferrite powder and compared to crushed ferrite cores. Due to their specific properties, the balls 1 enable a homogeneous mixture with a base material and to achieve a good flowability of the final magnetic mixture.

The ferrite balls 1 comprise a controlled (i.e. a specific) size. A diameter D of the respective ferrite ball 1 may be between 3 mm and 15 mm, where the limits are included. In one embodiment, only balls 1 of a predetermined size (e.g. 3 mm) form the filler material 10. In this case, a variation in the size of the balls 1 may be only marginal.

Alternatively, ferrite balls 1 of different (predetermined) sizes may be combined to form the filler material 10. For example, ferrite balls 1 comprising a diameter between 3 mm and 6 mm may be combined with one another or, alternatively, large ferrite balls 1 (e.g. balls 1 having a diameter of 10 mm or even more) may be combined with small ferrite balls 1 (e.g. balls 1 having a diameter of 4 mm, 5 mm or 6 mm). In this way, a filling factor of the filler material 10 in the final magnetic mixture, i.e. a mixing ratio between filler material 10 and the base material, may be optimized.

Due to the specific properties of the filler material 10, the magnetic mixture is very homogeneous, comprises a high filling factor and a good flowability. The filling factor may be ≥70 weight % or ≥50% in volume. The good flowability of the magnetic mixture and the controlled filling factor allows producers of magnetic concrete to use the casting process during construction work.

A conventional ferrite sintered powder can also be added to the magnetic mixture. This may take place before, after or at the same time as mixing the filler material 10 with the base material. By combining the ferrite balls 1 and the conventional ferrite sintered powder to obtain the magnetic mixture an even higher filling factor can be achieved.

The invention is not limited to the embodiments by the description based thereon. Rather, the invention encompasses any new feature as well as any combination of features, which in particular includes any combination of features in the claims, even if this feature or combination itself is not explicitly stated in the claims or embodiments.

1.-12. (canceled)

13. Balls comprising:
a ferrite material.

14. The balls according to claim 13, wherein the balls are sintered.

15. The balls according to claim 13, wherein the balls comprise a controlled size.

16. The balls according to claim 13, wherein the balls have a homogeneous shape.

17. The balls according to claim 13, wherein a diameter of the balls is 3 mm≤D≤15 mm.

18. The balls according to claim 13, wherein a density of the respective ball is ≤4200 kg/m³ and wherein the density is ≥3000 kg/m³.

19. The balls according to claim 13, wherein the balls are adapted to be used as a filler material for a magnetic mixture.

20. The balls according to claim 13, wherein the balls comprise a sintered spinel-structure of MnZn ferrites.

21. The balls according to claim 13, wherein the balls are formed by a disc pelletizing process and/or by a granulating process.

22. The balls according to claim 13, wherein the balls have a relative permeability ≥200.

23. The balls according to claim 13, wherein an outer surface of the balls is smooth.

24. A method for using a plurality of balls for doping a base material to obtain a magnetic mixture with specific magnetic properties, wherein the balls comprise a ferrite material.

25. Balls comprising:
a ferrite material, wherein a diameter of the balls is 3 mm≤D≤15 mm, wherein a density of the respective ball is ≤4200 kg/m³, and wherein the density is ≥3000 kg/m³.
